(19) United States
(12) Patent Application Publication
(10) Pub. No.: US 2010/0143773 A1
(43) Pub. Date: Jun. 10, 2010

(54) LITHIUM SECONDARY BATTERY, SECONDARY BATTERY MODULE, AND SECONDARY BATTERY PACK

(75) Inventor: Hidetoshi Honbou, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Vehicle Energy, Ltd., Ibaraki (JP)

(21) Appl. No.: 12/631,299

(22) Filed: Dec. 4, 2009

(30) Foreign Application Priority Data
Dec. 4, 2008 (JP) 2008-309596

(51) Int. Cl. H01M 6/10

(52) U.S. Cl. 429/94

(57) ABSTRACT

A lithium secondary battery having improved output power includes a plurality of wound electrode bodies in a battery can. Each wound electrode body is formed by winding a cathode and an anode with a separator placed the separator between the cathode and the anode. Each of the wound electrode bodies has a capacity of 1.5 Ah or less. The cathode includes a cathode current collector foil and cathode materials. End portions of the cathode are located on two end sides of the cathode current collector foil and include shorter sides of the cathode current collector foil, respectively. The active portion of the cathode has a cathode mixture deposited thereon and is sandwiched between the end portions. Cathode tabs extend from the end portions of the cathode current collector foil. The anode includes an anode current collector foil and anode materials, where both edges do not have an anode mixture.

### BACKGROUND OF THE INVENTION

1. Field of the Invention

The present invention relates to a lithium secondary battery, a secondary battery module, and a secondary battery pack. More particularly the invention relates to a lithium secondary battery which includes a wound electrode body that is formed by winding a cathode and an anode with a separator placed between the cathode and the anode and a battery case housing the wound electrode body, a secondary battery module having a plurality of the lithium secondary batteries, and a secondary battery pack having a plurality of the secondary battery modules.

2. Description of the Related Art

Lithium secondary batteries are widely used as power supplies for computers, mobile phones, etc. since the lithium secondary batteries have high energy densities and high output densities. While electric vehicles and hybrid vehicles have been developed as environment-friendly vehicles, lithium secondary batteries have been considered to be used as power supplies for vehicles. Some of the lithium secondary batteries for vehicles have already been in practical use. For electric and hybrid vehicles, it is important to increase the energy densities and battery lifetime.

The structure of a rectangular parallelepiped lithium secondary battery is disclosed. The rectangular parallelepiped lithium secondary battery has a wound electrode body formed by winding a cathode and an anode and a separator to ensure that the wound electrode body has a planar shape. The separator is located between the cathode and the anode. The wound electrode body is formed by pressing. The press-formed wound electrode body is housed in a rectangular parallelepiped battery can (refer to JP-A-2005-327527 as an example). The rectangular parallelepiped lithium secondary battery has been used for mobile phones and the like. However, when the rectangular parallelepiped lithium secondary battery of large type is used for an electric or hybrid vehicle, tightening pressure applied to an active portion of the rectangular parallelepiped wound electrode body is small, and the size of the battery is larger with ease. As a result, the lifetime of the battery may be disadvantageously reduced.

The following technique has been developed to increase the output power of a lithium secondary battery. In the technique, a plurality of current collector tabs protrude from each of a cathode and an anode, and the thicknesses of the current collector tabs are limited (refer to JP-A-2000-77055 as an example). On the other hand, the following technique has been developed to increase the output of a large battery for an electric vehicle or the like. In the technique, a secondary battery module has a plurality of cylindrical secondary batteries (refer to JP-A-2003-533844). In addition, there is known a technique relating to a secondary battery pack having a plurality of secondary battery modules connected with each other to increase the battery output.

### SUMMARY OF THE INVENTION

In the technique described in JP-A-2000-77055, the manufacturing process is complicated since installing the plurality of current collector tabs and alignment of the tabs are necessary, although an internal resistance of the battery case be reduced by using the plurality of current collector tabs. In other words, a plurality of current collector tabs can be led out to the wound electrode body formed by winding the cathode and the anode in principle. However, due to variations of the thicknesses of the cathode and the anode and the limitation of accuracy of the winding, the manufacturing process and the battery structure may be complex, and the yield may be reduced. In the structure of the arrayed cylindrical secondary batteries disclosed in JP-A-2003-533844, the ratio of parts such as a battery can to the secondary battery modules is large, resulting in reduced gravimetric energy density. It can be expected that a reduction in a resistance of a battery having a simple structure results in an increase in the output of a lithium secondary battery. It can also be expected that the reduction in the resistance leads to increases in the outputs of a secondary battery module and a secondary battery pack.

It is, therefore, an object of the present invention to provide a lithium secondary battery having high output power, a secondary battery module having a plurality of the lithium secondary batteries, and a secondary battery pack having a plurality of the secondary battery modules.

To achieve the aforementioned object, a lithium secondary battery according to an aspect of the present invention includes:

a plurality of wound electrode bodies, each of which is formed by winding a cathode and an anode with a separator placed between the cathode and the anode, each cathode including a current collector having a pair of end portions (inner and outer edges) and an active portion, said end portions being located on two end sides of the cathode current collector and including entire shorter sides of the cathode current collector respectively and not having an active material, said active portion having an active material deposited on both surfaces thereof and being sandwiched between the end portions, each anode including a current collector having a second pair of end portions and an active portion, said end portions being located on two end sides of the anode current collector and including entire shorter sides of the anode current collector respectively and not having an active material each active portion having an active material deposited on both surfaces thereof and being sandwiched between the second end portions;

a plurality of cathode conducting members, at least one of the cathode conducting members extending from each of the end portions of the cathode included in each of the wound electrode bodies;

a plurality of anode conducting members, at least one of the anode conducting members protruding from each of the second end portions of the anode included in each of the wound electrode bodies;

an electrolyte that infiltrates the wound electrode bodies; and

a battery case housing the wound electrode bodies, the cathode conducting members, the anode conducting members and the electrolyte, wherein

each of the wound electrode bodies has a capacity of 1.5 Ah or less, and

each of the cathode conducting members and the anode conducting members has a cross sectional area of 0.4 mm² in a direction crossing a direction in which a current flows in the electrode conducting member.

On the other side, to achieve the aforementioned object, a wound electrode body for lithium secondary battery includes:

a cathode, an anode, a separator located between the electrodes, and first and second cathode conducting members (12),

said first cathode conducting member extending from a central portion of the wound electrode body, and said second cathode conducting member extending from an exterior portion of the would electrode body; and

first and second anode conducting members (13), said first anode conducting member extending from a central portion of the wound electrode body, said second anode conducting member extending from an exterior portion of the would electrode body;

wherein said wound electrode body has a capacity of 1.5 Ah or less, and

wherein a cross sectional area of each of said anode conducting members is 0.4 mm² or less and of each of said cathode conducting members is 0.4 mm² or less.

According to the aspect, at least one elongated cathode conducting member protrudes from each of the end portions (of the cathode) located on both end sides of the cathode, and at least one elongated anode conducting member protrude from each of the end portions (of the anode) located on both end sides of the anode. Each of the cathode conducting member and the anode conducting member has a cross sectional area of 0.4 mm² or less. Thus, the lithium secondary battery has a reduced electrical resistance and improved output power. In addition, each of the wound electrode bodies has a capacity of 1.5 Ah or less. Thus, a current flowing in the cathode is evenly distributed, and a current flowing in the anode is evenly distributed. In addition, the lithium secondary battery has a reduced resistance.

In the aspect, the wound electrode bodies may be connected in parallel in the battery case so as to connect the cathode conducting members to each other and connect the anode conducting members to each other. The lithium secondary battery may be formed to ensure that: the cathode conducting members protrude from the end portions of the cathode included in each of the wound electrode bodies, respectively; the anode conducting members protrude from the end portions of the anode included in each of the wound electrode bodies, respectively; and the cathode conducting members and the anode conducting members of each of the wound electrode bodies extend in the same direction toward the same side with respect to the center of the wound electrode body. Each of the wound electrode bodies may have a circle, square or rectangular cross section in a direction crossing a winding axis of the wound electrode body. The lithium secondary battery may include a cathode current conductive plate and an anode current conductive plate. In this case, the cathode current conductive plate connects the cathode conducting members to each other, and the anode current conductive plate connects the anode conducting members to each other. The wound electrode bodies may be arranged in line and housed in the battery case to ensure that the cathode current conductive plate is provided on the bottom side of the battery case and that an insulating member is provided between the cathode current conductive plate and the battery case. The lithium secondary battery may be formed to ensure that the cathode current conductive plate has a cathode plate portion (first plate portion) and a side plate portion and that the anode current conductive plate may have an anode plate portion (second plate portion) located on the side opposite to the bottom side of the battery case. In this case, the first plate portion is located between the wound electrode bodies and the bottom surface of the battery case. The side plate portion is bent with respect to the first plate portion and extends in longitudinal directions of the wound electrode bodies and is located on the side of one of side surfaces of the wound electrode bodies. The first plate portion and the side plate portion form an L shape. The lithium secondary battery may have an external electrode terminal and an external anode terminal. In this case, the cathode current conductive plate has a first lead portion that is bent with respect to the side plate portion and connected with the external cathode terminal, and the anode current conductive plate has a second lead portion that is bent with respect to the second plate portion and connected with the external anode terminal. Also, in this case, the first and second lead portions are bent toward opposite sides to each other. The cathode current conductive plate may have a cross sectional area larger than that of each of the cathode conducting members. The cross sectional area of each of the cathode conducting members is in a direction crossing a direction in which a current flows in the cathode conducting member. The anode current conductive plate may have a cross sectional area larger than that of each of the anode conducting members. The cross sectional area of each of the anode conducting members is in a direction crossing a direction in which a current flows in the anode conducting member. The cathode current conductive plate may have a contact member that protrudes from the side plate portion and becomes in contact with outer circumferential portions of the wound electrode bodies.

To achieve the aforementioned object, a lithium secondary battery module according to another aspect of the present invention includes a plurality of the lithium secondary batteries according to the aforesaid aspect, wherein the lithium secondary batteries are arranged in line and a spacer forms a gap between each adjacent pair of the lithium secondary batteries. It is preferable that some of the spacers be located between each adjacent pair of the lithium secondary batteries arranged in upper and lower layers and that some of the spacers be located between each adjacent pair of the lithium secondary batteries arranged in a single row.

A lithium second battery pack according to another aspect of the present invention includes a plurality of the lithium secondary battery modules according to the aforesaid aspect, a control circuit, and an exterior case. The controls circuit controls battery states of the lithium secondary batteries forming each of the lithium secondary battery modules. The exterior case houses the plurality of lithium secondary battery modules and the control circuit. The lithium secondary battery modules included in the lithium secondary battery pack may be arranged in a single layer and connected in series to each other. It is preferable that the exterior case has a heat releasing fan that releases internal heat to the outside of the case.

According to the present invention, at least one elongated cathode conducting member protrudes from each of the end portions (non-deposition portions) located on both end sides of the cathode, and at least one elongated anode conducting member protrudes from each of the end portions (non-deposition portions) located on both end sides of the anode. Each of the cathode conducting members and the anode conducting members has a cross sectional area of 0.4 mm² or less. Thus, the lithium secondary battery has a reduced electrical resistance and increased output power. Each of the wound electrode bodies has a capacity of 1.5 Ah or less. Thus, a current flowing in the cathode and the anode of each of the wound electrode bodies is evenly distributed. In addition, the lithium secondary battery has a reduced resistance.

### BRIEF DESCRIPTION OF THE DRAWINGS

Other objects and advantages of the invention will become apparent from the following description of embodiments with reference to the accompanying drawings in which:

FIG. 1 is a plan view of a cathode, an anode and two separators of a rectangular parallelepiped lithium secondary battery used for a lithium secondary battery module forming a part of a lithium secondary battery pack according to an embodiment of the present invention, showing the states of the cathode and the anode and separators before winding;

FIG. 2A is a perspective view of a wound electrode body that has a square or rectangular cross section and is formed by winding the cathode and the anode and the two separators to ensure that one of the separators is located between the cathode and the anode;

FIG. 2B is a perspective view of a wound electrode body that has a circular cross section and is formed by winding the cathode and the anode and the two separators to ensure that one of the separators is located between the cathode and the anode;

FIG. 3 is a perspective view of the wound electrode body that forms a part of a rectangular parallelepiped lithium secondary battery and has cathode tabs protruding from one of end surfaces of the wound electrode body and anode tabs protruding from the other end surface of the wound electrode body;

FIG. 4 is a perspective view of a wound electrode body group having four wound electrode bodies and forming a part of the rectangular parallelepiped lithium secondary battery;

FIG. 5 is a perspective view showing a positional relationship of the wound electrode body group, a cathode current conductive plate, and an anode current conductive plate, which form the rectangular parallelepiped lithium secondary battery;

FIG. 6 is a perspective view showing a state in which the wound electrode body group is connected with the cathode current conductive plate and the anode current conductive plate;

FIG. 7 is an exploded perspective view of the rectangular parallelepiped lithium secondary battery.

FIG. 8 is a cross sectional view of a conventional rectangular parallelepiped lithium secondary battery;

FIG. 9 is a perspective view of a lithium secondary battery module that form a part of a lithium secondary battery pack according to the embodiment and has eight rectangular parallelepiped lithium secondary batteries connected in series to each other;

FIG. 10 is a perspective view of the lithium secondary battery module forming a part of the lithium secondary battery pack according to the embodiment.

FIG. 11 is a perspective view of the lithium secondary battery pack according to the embodiment; and

FIG. 12 is a graph showing variations of resistance increase rates with respect to the number of pulse cycles of the rectangular parallelepiped lithium secondary battery described in a first example and with respect to the number of pulse cycles of a rectangular parallelepiped lithium secondary battery described in a comparative example.

### DESCRIPTION OF THE PREFERRED EMBODIMENTS

The following describes an embodiment of a lithium secondary battery pack according to the present invention with reference to the accompanying drawings.

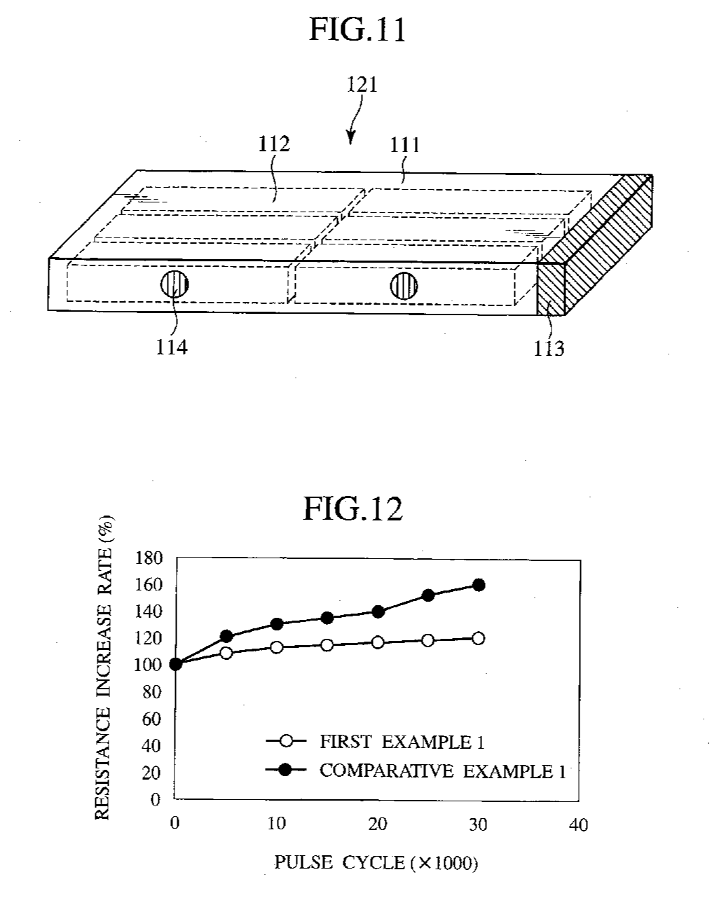

FIG. 11 shows the lithium secondary battery pack denoted by reference numeral 121. The lithium secondary battery pack 121 has a thin rectangular parallelepiped exterior case 111. The exterior case 111 houses six lithium secondary battery modules 112. Each of the lithium secondary battery modules 112 includes eight rectangular parallelepiped lithium secondary batteries 91.

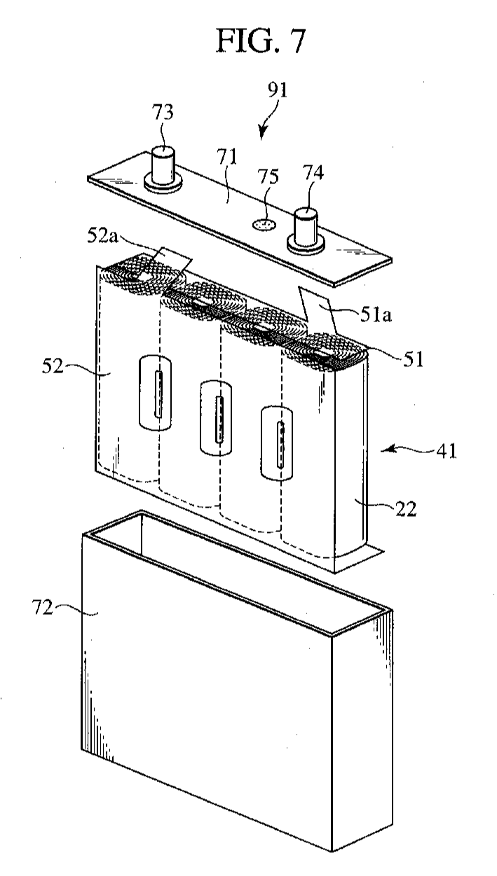

Referring to FIG. 7, the lithium secondary battery 91 (included in the lithium secondary battery module 112) has a battery can 72. The battery can 72 has an opening and houses a wound electrode body group 41 having four wound electrode bodies 22. Each of the wound electrode bodies 22 is formed by winding a cathode and an anode. The four wound electrode bodies 22 are arranged in line. That is, the four wound electrode bodies 22 are arranged side by side. Each of the wound electrode bodies 22 has cathode tabs (described later) and anode tabs (described later). The cathode tabs of each of the wound electrode bodies 22 protrude from one of end surfaces of the wound electrode body 22. The anode tabs of each of the wound electrode bodies 22 protrude from the other end surface of the wound electrode body 22. The battery can 72 houses the wound electrode body group 41 to ensure that the end surface of each of the wound electrode bodies 22, from which the cathode tabs protrude, is located on the bottom side of the battery can 72. The wound electrode body group 41 is connected with a cathode current conductive plate 52 and an anode current conductive plate 51. The lithium secondary battery 91 has an insulating material located between an inner surface of the battery can 72 or battery lid 71 and the cathode current conductive plate 52 and the anode current conductive plate 51. The battery can 72 has a thickness larger than that of the wound electrode body group 41. The battery can 72 is sealed by a rectangular flat battery lid 71 at the opening of the battery can 72. The battery lid 71 has a cathode terminal 73 and an anode terminal 74. The cathode terminal 73 and the anode terminal 74 are arranged in a longitudinal direction of the rectangular flat battery lid 71. That is, the cathode terminal 73 is arranged on one end side of the battery lid 71, while the anode terminal 74 is arranged on the other end side of the battery lid 71. The battery lid 71 has a liquid port 75 from which a nonaqueous electrolyte is poured into the battery can 72. After the nonaqueous electrolyte is poured from the liquid port 75 into the battery can 72, the liquid port 75 is sealed.

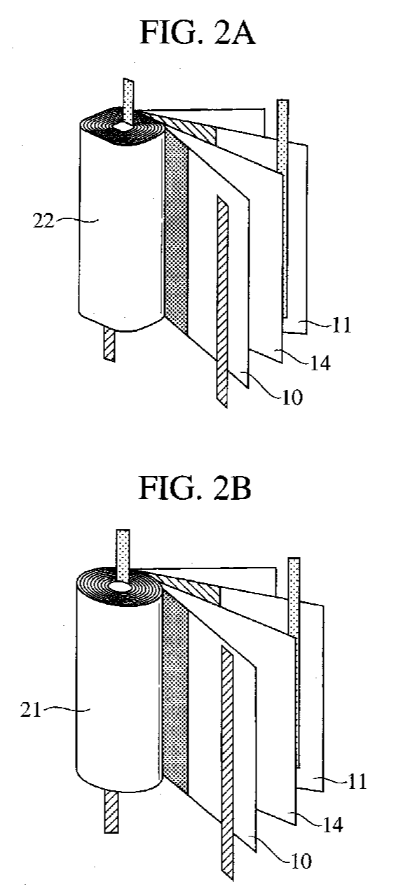

Referring to FIG. 2A, reference numeral 10 denotes the cathode, reference numeral 11 denotes the anode, and reference numeral 14 denotes a separator. Each of the wound electrode bodies 22 is formed by winding the cathode 10, the anode 11 and the separators 14 with one of the separators 14 provided between the cathode 10 and the anode 11. Each of the wound electrode bodies 22 has a square cross section in a direction crossing a winding axis of the wound electrode body. Each of the cathode tab and the anode tab has an elongated shape. The cathode tabs are attached to the cathode 10. The cathode tabs are located on both end sides of the cathode 10, respectively. The anode tabs are attached to the anode 11. The anode tabs are located on both end sides of the anode 11, respectively. Each of the cathode tab and the anode tab has a cross-sectional area (in a direction crossing a direction in which a current flows in the electrode tab) of 0.16 mm² to 0.4 mm². This structure suppresses to a minimum extent deformation (distortion) of each of the wound electrode bodies 22 caused by the cathode tab and the anode tab in a process of winding the cathode 10 and the anode 11. Each of the wound electrode bodies 22 has a capacity of 0.8 Ah to 1.5 Ah.

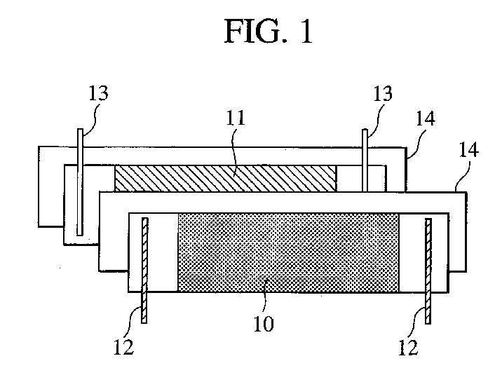

Referring to FIG. 1, the cathode 10, the anode 11 and the separators 14 are rectangular. The cathode 10, the anode 11 and the separators 14 form the wound electrode body 22. The wound electrode body 22 is formed by laminating the separator 14, the anode 11, the separator 14 and the cathode 10 in this order and winding the separators 14 and the cathode 10 and the anode 11 from their one ends including their shorter sides. The cathode 10 includes a rectangular current collector foil (current collector). The cathode current collector foil has an active portion (deposition portion) in a longitudinal direction of the current collector and two end portions (non-deposition portions) in the longitudinal direction. A cathode mixture is deposited on both surfaces of the active portion of the cathode current collector foil, and is not deposited on the end portions of the cathode current collector foil. One of the end portions of the cathode current collector foil is located on one of end sides of the cathode current collector foil and includes one entire shorter side of the cathode current collector foil. The other end portion of the cathode current collector foil is located on the other end side of the cathode current collector foil and includes the other entire shorter side of the cathode current collector foil. The active portion of the cathode current collector foil is sandwiched between the two end portions of the cathode current collector foil. The cathode current collector foil is exposed in the end portions. One of the cathode tabs 12 is attached to one of the end portions of the cathode current collector foil, while the other cathode tab 12 is attached to the other end portion of the cathode current collector foil. One end of one of the two cathode tabs 12 protrudes from one of end sides of the cathode current collector foil, while one end of the other cathode tab 12 protrudes from the other end side of the cathode current collector foil. The anode 11 includes a rectangular current collector foil (current collector). The anode current collector foil has an active portion and two end portions. An anode mixture is deposited on both surfaces of the active portion of the anode current collector foil, and is not deposited on the end portions of the anode current collector foil. One of the end portions of the anode current collector foil is located on one of end sides of the anode current collector foil and includes one entire shorter side of the anode current collector foil. The other end portion of the anode current collector foil is located on the other end side of the anode current collector foil and includes the other entire shorter side of the anode current collector foil. The active portion of the anode current collector foil is sandwiched between the two end portions of the anode current collector foil. The anode current collector foil is exposed in the end portions. One of the anode tabs 13 is attached to one of the end portions of the anode current collector foil, while the other anode tab 13 is attached to the other end portion of the anode current collector foil. One end of one of the two anode tabs 12 protrudes from one of end sides of the anode current collector foil, while one end of the other anode tab 12 protrudes from the other end side of the anode current collector foil. The cathode tabs 12 protrude from one of end surfaces of the wound electrode body 22, while the anode tabs 13 protrude from the other end surface of the wound electrode body 22. Ultrasonic welding, resistance welding, laser welding, grommets or the like may be used to connect the cathode current collector foil with the cathode tabs 12 and connect the anode current collector foil with the anode tabs 13. Aluminum may be used as materials of the cathode tabs. Copper, nickel, or copper plated with nickel may be used as materials of the anode tabs 13. In the present embodiment, aluminum is used as the materials of the cathode tabs 12, and nickel is used as the materials of the anode tabs 13.

An aluminum foil is used as the current collector foil of the cathode 10. The cathode mixture deposited on both surfaces of an active portion of the aluminum foil contains a cathode active material (capable of absorbing and releasing a lithium ion), activated carbon, a conductive material, and a binder. A complex compound of lithium and a transition metal(s) is used as the cathode active material. The complex compound has a crystal structure such as a spinel type cubic system, a layered hexagonal system, an olivin type cubic system, or a triclinic system. A layered hexagonal system including lithium, nickel, manganese and cobalt is preferable in order to achieve high output power, a high energy density and a long operating lifetime. The following system is more preferable: a layered hexagonal system including a compound represented by a chemical formula, LiMnₐNi_{b}Co_{c}M_{d}O₂ (M is at least one selected from a group consisting of Fe, V, Ti, Cu, Al, Sn, Zn, Mg and B, preferably at least one selected from a group consisting of Fe, V, Al, B and Mg; 0≦a≦0.6; 0.3≦b≦0.6; 0≦c≦0.4; and 0≦d≦0.1).

The cathode active material is formed in the following way. That is, powder of each of the raw materials of the cathode active material is prepared to ensure that ratios of the amounts of the raw materials to the total amount are desirable. The powder of the raw materials is pulverized and mixed by a mechanical method such as ball milling. The pulverization and the mixture may be carried out by dry ball milling or by wet ball milling. The pulverization and the mixture are carried out to ensure that the diameters of particles of the pulverized and mixed raw material powder are equal to or smaller than 1 μm, preferably equal to or smaller than 0.3 μm. In addition, it is preferable that the obtained raw material powder be spray-dried and granulated. The raw material powder pulverized and mixed in this way is fired at 850° C. to 1100° C., preferably at 900° C. to 1050° C. The firing operation is carried out under an oxidation gas atmosphere (such as an oxygen atmosphere or air), an inert gas atmosphere (such as nitrogen gas or argon gas), or an atmosphere obtained by combining them. In the present embodiment, the diameters of particles of the cathode active material are adjusted to 10 μm or less.

Blocky graphite, flaky graphite, or amorphous carbon (such as carbon black) is used as the conductive material. Each of the blocky graphite, flaky graphite, and amorphous carbon has a length Lc of 100 nm in the direction of the c axis of the carbon crystal lattice and is highly conductive. Those carbon materials may be used in combination as the conductive material. When the blocky graphite is used as the conductive material, the weight percent of the blocky graphite relative to the weight of the cathode mixture including the conductive material is adjusted to a range of 3 to 12. When the flaky graphite is used as the conductive material, the weight percent of the flaky graphite relative to the weight of the cathode mixture including the conductive material is adjusted to a range of 1 to 7. When the amorphous carbon is used as the conductive material, the weight percent of the amorphous carbon relative to the weight of the cathode mixture including the conductive material is adjusted to a range of 0.5 to 7. When the weight percent of the blocky graphite is less than 3, the conductive network of the cathode mixture is not sufficient. When the weight percent of the blocky graphite is more than 12, the relative amount of the cathode active material to the total amount of the cathode mixture is small. This results in a reduction in the battery capacity. When the weight percent of the flaky graphite is less than 1 and the flaky graphite is replaced with another conductive material, the effect of reducing the conductive material is reduced. When the weight percent of the flaky graphite is more than 7, the average diameter of particles of the cathode mixture is increased. The increase in the average diameter results in formation of gaps in the cathode mixture and thereby results in a significant reduction in the density of the cathode. The amorphous carbon with a weight percent of less than 0.5 is not sufficient to connect gaps present between cathode materials. When the weight percent of the amorphous carbon is more than 7, the density of the cathode is significantly reduced.

A copper foil is used as the current collector foil of the anode 11. The anode mixture deposited on both surfaces of the active portion of the copper foil contains an anode active material (capable of absorbing and releasing a lithium ion), a conductive material, and a binder. The following materials may be used as the anode active material: metal lithium, a carbon material, and a material capable of containing a lithium ion or forming a compound containing a lithium ion. The carbon material is suitable as the anode active material. As the carbon material, the following materials may be used: graphite such as natural graphite and artificial graphite; and amorphous carbon such as coal coke, carbide of coal pitch, petroleum coke, carbide of petroleum pitch, and carbide of pitch coke. In addition, the following materials may also be used as the anode active material: a material obtained by carrying out various types of surface processing on those carbon materials; and a material obtained by combining two or more of those carbon materials. As the material capable of containing a lithium ion or forming a compound containing lithium, the following may be used: metals such as aluminum, tin, silicon, indium, gallium, and magnesium; an alloy of at least one of those metals; and a metal oxide containing tin and silicon. In addition, the following composite material may be used as the material capable of containing a lithium ion of forming a compound containing a lithium ion: a composite material of at least one of the metals, the alloy and the metal oxide, and graphite or an amorphous carbon material. The average diameter of particles of the anode active material is adjusted to 20 μm or less in the present embodiment.

The cathode 10 and the anode 11 are formed in the following ways. First, the cathode active material, the conductive material (blocky graphite, flaky graphite, amorphous carbon or a material obtained by combining them), and a binder (such as polyvinylidene fluoride (PVDF)) are mixed to form slurry. In this case, in order that the cathode active material, the conductive material, and the binder are uniformly dispersed in the slurry, the mixing is sufficiently carried out by a dispersion mixer. The thus-formed slurry is coated on both surfaces of the aluminum foil having a thickness of 15 to 25 μm with a roll transfer type coater or the like. In this case, the non-deposition portions (end portions) of the cathode mixture are formed. The non-deposition portions are located on both end sides of the aluminum foil. After the coating, press drying is carried out on the aluminum foil. In this way, the cathode 10 is formed. The thickness of the portion, on which the cathode mixture containing the cathode active material, the conductive material and the binder is deposited, is adjusted to 20 μm to 100 μm. To form the anode 11, the anode active material and the binder are mixed to form slurry in a way similar to the formation of the cathode 10. The thus-formed slurry is coated on both surfaces of an active portion of the copper foil having a thickness of 7 μm to 20 μm. After the coating, press drying is carried out on the copper foil. In this way, the anode 11 is formed. The thickness of the portion, on which the anode mixture is deposited, is adjusted to 20 μm to 70 μm. In the present embodiment, the anode mixture contains 90 weight percent of the anode active material and 10 weight percent of the binder.

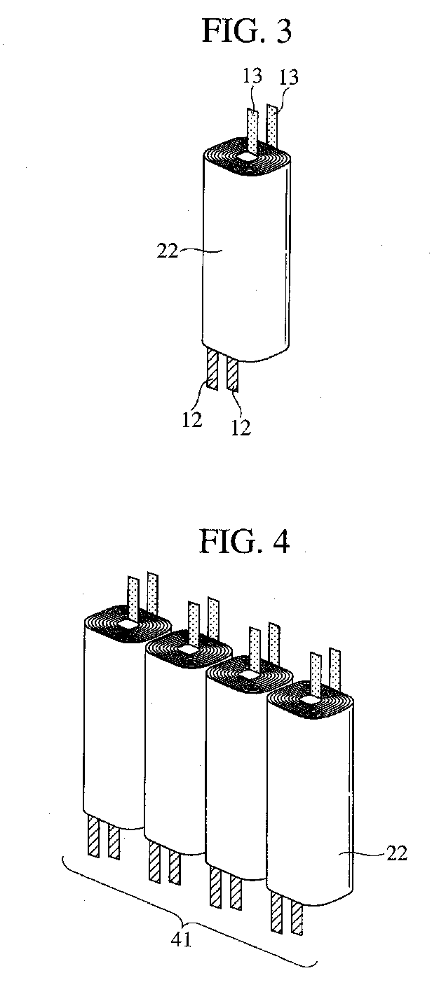

As shown in FIG. 3, the wound electrode body 22 is formed by winding the thus-formed cathode 10 and anode 11 with one of the separators 14 placed between the cathode 10 and the anode 11. The wound electrode body 22 has a square cross section. It is, therefore, easy to arrange the wound electrode bodies 22 (forming the wound electrode body group 41) in a flat shape. The wound electrode body group 41 having the wound electrode bodies 22 arranged in line is formed such that a gap between each adjacent pair of the wound electrode bodies 22 is made smaller. The two cathode tabs 12 of each of the wound electrode bodies 22 extend in the same direction toward the same side with respect to the center of the wound electrode body 22 from both end sides of the cathode current collector foil, respectively. The two cathode tabs 12 of each of the wound electrode bodies 22 protrude from one end surface of the wound electrode body 22. The two anode tabs 13 of each of the wound electrode bodies 22 extend in the same direction toward the same side with respect to the center of the wound electrode body 22 from both end sides of the anode current collector foil, respectively. The two anode tabs 13 of each of the wound electrode bodies 22 protrude from the other end surface of the wound electrode body 22. Referring to FIG. 4, the four wound electrode bodies 22 that form the wound electrode body group 41 are arranged in line and in a flat shape). Thus, the wound electrode body group 41 can be easily housed in the thin rectangular parallelepiped battery can 72.

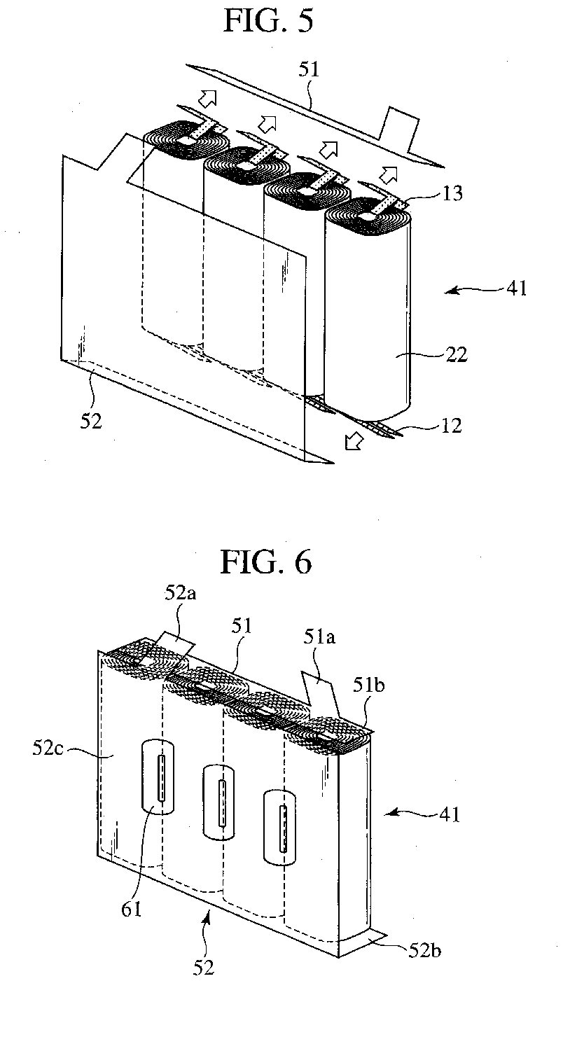

Referring to FIG. 5, the cathode current conductive plate 52 and the anode current conductive plate 51 are attached to the wound electrode body group 41. The cathode current conductive plate 52 connects the cathode tabs 12 to each other, while the anode current conductive plate 51 connects the anode tabs 13 to each other. The anode tabs 13 extending from the end surface of each of the wound electrode bodies 22 are bent and connected with the anode current conductive plate 51. The cathode tabs 12 extending from the other end surface of each of the wound electrode bodies 22 are connected with the cathode current conductive plate 52. In other words, the four wound electrode bodies 22 forming the wound electrode body group 41 are connected in parallel with each other via the cathode current conductive plate 52 and the anode current conductive plate 51. Ultrasonic welding, resistance welding, laser welding or the like may be used for connecting the anode current collector plate 51 with the anode tabs 13 and connecting the cathode current conductive plate 52 with the cathode tabs 12.

Referring to FIG. 6, the cathode current conductive plate 52 has a cathode plate portion (first plate portion) 52b, a side plate portion 52c, and a cathode lead portion (first lead portion) 52a. The cathode plate portion 52b is located on the side of the end surfaces (of the four wound electrode bodies 22) from which the cathode tabs 12 protrude. The side plate portion 52c is bent with respect to the cathode plate portion 52b. The side plate portion 52c extends in the longitudinal direction of the wound electrode bodies 22 and is located on the side of one side surface of the wound electrode bodies 22. The side plate portion 52c and the cathode plate portion 52b form an L shape. The cathode lead portion 52a is bent with respect to the side plate portion 52c. The surface of the cathode lead portion 52a and the surface of the side plate portion 52c (extending along the winding axes of each wound electrode body 22) form an acute angle. The cathode lead portion 52a is located on one of the end sides of the wound electrode body group 41. In other words, the cathode lead portion 52a is located on the side of one of the wound electrode bodies 22 arranged at the ends of the wound electrode body group 41. The anode current conductive plate 51 has an anode plate portion (second plate portion) 51b and an anode lead portion (second lead portion) 51a. The anode plate portion 51b is located on the side of the end surfaces (of the four wound electrode bodies 22) from which the anode tabs 13 protrude. The anode lead portion 51a is bent with respect to the anode plate portion 51b. The surface of the anode lead portion 51a and the direction of the winding axis of each wound electrode body 22 form an acute angle.

The cathode lead portion 52a and the anode lead portion 51a are bent toward opposite sides to each other, i.e., toward the side of the centers of the end surfaces of the wound electrode bodies 22. The cathode current conductive plate 52 has a cross section larger than those (in a direction crossing directions in which currents flow in the cathode tabs 12) of the cathode tabs 12. The anode current conductive plate 51 has a cross section larger than those (in a direction crossing directions in which currents flow in the anode tabs 13) of the anode tabs 13. The cathode tabs 12 of the wound electrode bodies 22 are connected to the cathode plate portion 52b. The anode tabs 13 of the wound electrode bodies 22 are connected to the anode plate portion 51b. The cathode lead portion 52a is connected to the cathode terminal 73. The anode lead portion 51a is connected to the anode terminal 74.

The cathode current conductive plate 52 has guide portions 61 as contact members. Each of the guide portions 61 protrudes from the side plate portion 52c and is in contact with outer circumferential portions of any adjacent two of the wound electrode bodies 22 forming the wound electrode body group 41. Each of the guide portions 61 is located between the two adjacent wound electrode bodies 22 and in a central region placed between sides (extending in the longitudinal direction of the wound electrode body group 41) of the side plate portions 52c. Each of the guide portions 61 fits the shape of a recessed portion formed between the adjacent wound electrode bodies 22. The guide portions 61 are formed on the cathode current conductive plate 52 by pressing.

### <Battery Assembling>

The lithium secondary battery 91 is assembled in the following way. The cathode tabs 12 are attached to the non-deposition portions (located on both end sides of the cathode 10) of the formed cathode 10 by ultrasonic welding. The anode tabs 13 are attached to the non-deposition portions (located on both end sides of the anode 11) of the formed anode 11 by ultrasonic welding. The cathode tabs 12 are made of aluminum. The anode tabs 13 are made of nickel. The cathode 10 and the anode 11 are wound to ensure that the wound electrode body 22 has a square cross section and that the separator 14 made of a porous polyethylene film is provided between the cathode 10 and the anode 11 (refer to FIG. 2A). Each of the wound electrode bodies 22 has a capacity of 1.5 Ah. As shown in FIG. 5, the four wound electrode bodies are arranged in line. The cathode tabs 12 are connected to the cathode current conductive plate 52 (cathode plate portion 52b). The anode tabs 13 are connected to the anode current conductive plate 51 (anode plate portion 51b). The wound electrode body group 41 connected to the cathode current conductive plate 52 and the anode current conductive plate 51 is housed in the battery can 72. In this case, the cathode plate portion 52b connected with the cathode tabs 12 is located on the bottom side of the battery can 72. The cathode lead portion 52a is connected to the cathode terminal 73, while the anode lead portion 51a is connected to the anode terminal 74 (refer to FIG. 7). After the opening of the battery can 72 is sealed by the battery lid 71, a nonaqueous electrolyte (organic electrolyte) is poured from the liquid port 75 into the battery can 72. The battery can 72 is then sealed by closing the liquid port 75. In this way, the lithium secondary battery 91 is assembled. Since the capacity of each wound electrode body 22 is in a range of 0.8 Ah to 1.5 Ah, the capacity of the lithium secondary battery 91 is in a range of 3.2 Ah to 6.0 Ah.

The nonaqueous electrolyte is prepared by dissolving an electrolyte (such as lithium hexafluorophosphate (LiPF₆), lithium tetrafluoroborate (LiBF₄), or lithium perchlorate (LiClO₄)) in a solvent (such as diethyl carbonate (DEC), dimethyl carbonate (DMC), ethylene carbonate (EC), propylene carbonate (PC), vinylene carbonate (VC), methyl acetate (MA), ethylmethyl carbonate (EMC), or methyl propyl carbonate (MPC)). The concentration of the electrolyte can be set to a range of 0.7 M to 1.5 M. In the present embodiment, the nonaqueous electrolyte is prepared by dissolving LiPF₆ of 1 mol/l in a mixed solvent containing EC, DMC and EMC. In this case, the volume ratios of the EC, DMC and EMC are 1:1:1.

Referring to FIGS. 9 and 10, the lithium secondary battery module 112 includes eight lithium secondary batteries 91. Four of the eight lithium secondary batteries 91 are arranged in a lateral direction in a single layer. The other four lithium secondary batteries 91 are arranged in a lateral direction in another layer. That is, the four lithium secondary batteries 91 arranged in the single layer are located below the other four lithium secondary batteries 91 arranged in the other layer. The lithium secondary battery module 112 is formed into a rectangular parallelepiped shape. The lithium secondary battery module 112 has end plates 101 on both end sides thereof. That is, the end plates 101 are located on the sides of the two wound electrode bodies arranged at the ends of the upper (or lower) layer, respectively. The lithium secondary battery module 112 also has four tightening plates 102. Two of the tightening plates 102 extend in the longitudinal direction of the lithium secondary battery module 112 and are located above the four lithium secondary batteries 91 arranged in the upper layer. The two tightening plates 102 are located on both sides of the upper surface of the lithium secondary battery module 112. The other two tightening plates 102 extend in the longitudinal direction of the lithium secondary battery module 112 and are arranged below the other four lithium secondary batteries 91 arranged in the lower layer. The two tightening plates 102 are located on both sides of the lower surface of the lithium secondary battery module 112. The two end plates 101 are tightened by means of the four tightening plates 102 to ensure that each of the lithium secondary batteries 91 is fixed.

The lithium secondary battery module 112 also has spacers 92 that form gaps between parts. Some of the spacers 92 are located between each adjacent pair of the lithium secondary batteries 91 arranged in the upper and lower layers. Some of the spacers 92 are located between each adjacent pair of the adjacent lithium secondary batteries 91 arranged in the same layer. Some of the spacers 92 are located between the four lithium secondary batteries 91 arranged at the ends of the two layers and the end plates 101. Some of the spacers 92 are located between the lithium secondary batteries 91 arranged in the upper layer and the tightening plates 102 arranged on both sides of the upper surface of the lithium secondary battery module 112. The other spacers 92 are located between the lithium secondary batteries 91 arranged in the lower layer and the tightening plates 102 arranged on both sides of the lower surface of the lithium secondary battery module 112. In other words, two of the spacers 92 are located between each adjacent pair of the lithium secondary batteries 91 arranged in the same layer. One of the two spacers 92 is located on the side of the battery lid 71, and the other spacer 92 is located on the bottom side of the battery can 72. Four of the spacers 92 are located between each adjacent pair of the lithium secondary batteries 91 arranged in the upper and lower layers and are respectively located on four corners of the facing surface of the lithium secondary battery 91 arranged in the lower layer (or respectively located under four corners of the facing surface of the lithium secondary battery 91 arranged in the upper layer). Four of the spacers 92 are respectively located on the four corners of the upper surface of each of the lithium secondary batteries 91 arranged in the upper layer and are located between the lithium secondary battery 91 and the tightening plates 102 arranged on the upper side of the module 112. Four of the spacers 92 are respectively located under the four corners of the lower surface of each of the lithium secondary batteries 91 arranged in the lower layer and are located between the lithium secondary battery 91 and the tightening plates 102 arranged on the lower side of the module 112. Two of the spacers 92 are located between one of the two end plates 101 and the lithium secondary battery 91 arranged at one of the ends of the upper layer. One of the two spacers 92 is located on the side of the battery lid 71, and the other spacer 92 is located on the bottom side of the battery can 72. Two of the spacers 92 are located between the other end plate 101 and the lithium secondary battery 91 arranged at the other end of the upper layer. One of the two spacers 92 is located on the side of the battery lid 71, and the other spacer 92 is located on the bottom side of the battery can 72. In addition, two of the spacers 92 are located between one of the two end plates 101 and the lithium secondary battery 91 arranged at one of the ends of the lower layer. One of the two spacers 92 is located on the side of the battery lid 71, and the other spacer 92 is located on the bottom side of the battery can 72. Two of the spacers 92 are located between the other end plate 101 and the lithium secondary battery 91 arranged at the other end of the lower layer. One of the two spacers 92 is located on the side of the battery lid 71, and the other spacer 92 is located on the bottom side of the battery can 72. Thus, the four spacers 92 are located between the end plate 101 and the lithium secondary batteries 91 arranged at the one-side ends of the upper and lower layers. The four spacers 92 are located between the other end plate 101 and the lithium secondary batteries 91 arranged at the other-side ends of the upper and lower layers. The spacers 92 form the gaps around the lithium secondary batteries 91 constituting the lithium secondary battery module 112. The material and shape of each spacer 92 are not restricted. In the present embodiment, the spacers 92 are made of heat-resistant resin and formed into thin rectangular parallelepiped shapes.

A plate-shaped connecting metal fitting 93 is connected by welding to the cathode terminal 73 of each lithium secondary battery 91 and the anode terminal 74 of the adjacent lithium secondary battery 91. Thus, the eight lithium secondary batteries 91 included in the lithium secondary battery module 112 are connected in series by the connecting metal fittings 93. The cathode terminal 73 of the lithium secondary battery 91 located at one end of the upper layer serves as a cathode terminal 16 of the lithium secondary battery module 112. The anode terminal 74 of the lithium secondary battery 91 located at one end of the lower layer serves as an anode terminal 15 of the lithium secondary battery module 112. The cathode terminal 73 serving as the cathode terminal 16, and the anode terminal 74 serving as the anode terminal 15, are located on the same side.

Referring to FIG. 11, the lithium secondary battery pack 121 includes six lithium secondary modules 112 in the exterior case 111. Two of the lithium secondary modules 112 are arranged longitudinally in each of three rows. Three of the lithium secondary modules 112 are arranged in each of two columns in a direction crossing the longitudinal direction of the exterior case 111. Therefore, the six lithium secondary modules 112 are arranged in the two columns and the three rows and in a single layer. The six lithium secondary modules 112 are connected in series. The exterior case 111 also houses a control circuit 113. The control circuit 113 is located on an end side of the lithium secondary battery pack 121. That is, the control circuit is located adjacent to one shorter side of the thin rectangular parallelepiped exterior case 111. The control circuit 113 is used to monitor and control the battery states of the lithium secondary batteries 91 included in the lithium secondary battery modules 112. The exterior case 111 has two cooling fans 114 attached thereto. The cooling fans 114 serve as heat releasing fans and are arranged on one side surface extending in the longitudinal direction of the exterior case 111. The two cooling fans 114 are respectively arranged at locations associated with substantially active portions of side surfaces of respective columns of the lithium secondary battery modules 112. The side surfaces of the lithium secondary battery modules 112 face the side surface of exterior case 111 to which the heat release fans 114 are attached. The cooling fans 114 release, to the outside of the exterior case 111, hot air generated by the lithium secondary batteries 91 forming the lithium secondary battery modules 112 housed in the exterior case 111.

The control circuit 113 has a voltage measurement circuit, an abnormal voltage determination section, and a bypass circuit. The voltage measurement circuit measures a voltage of each of the lithium secondary batteries 91 forming each of the lithium secondary battery modules 112. The abnormal voltage determination section determines that when the voltage measured by the voltage measurement circuit exceeds a predetermined upper voltage limit, the measured voltage of the lithium secondary battery 91 is abnormal. The bypass circuit is connected in parallel with each of the lithium secondary batteries 91. The bypass circuit bypasses a current flowing in the lithium secondary battery 91 of which the voltage is determined to be abnormal. The abnormal voltage determination section determines that the voltage of the lithium secondary battery 91 is abnormal when the voltage measured by the voltage measurement circuit exceeds the upper voltage limit. When the abnormal voltage determination section determines that a voltage of at least one of the lithium secondary batteries 91 is abnormal, the bypass circuit operates such that the lithium secondary battery 91 outputting the abnormal voltage is discharged until the abnormal voltage of the lithium secondary battery 91 becomes equal to the average voltage of the other lithium secondary batteries 91. When the abnormal voltage is returned to a normal voltage (the voltage measurement circuit determines no longer that the voltage is abnormal), the bypass circuit is shut off to ensure that the lithium secondary battery pack 121 performs a normal charging and discharging state.

### Operations

Next, the following describes operations of the lithium secondary battery pack 121, lithium secondary battery module 112 forming a part of the lithium secondary battery pack 121, lithium secondary battery 91 forming a part of the lithium secondary battery module 112 according to the present embodiment. The lithium secondary battery 91, the lithium secondary battery module 112 and the lithium secondary battery pack 121 are described below in this order.

The two elongated cathode terminal tabs 12 of each of the wound electrode bodies 22 forming the lithium secondary battery 91 extend from the two non-deposition portions (end portions) of the cathode 10, respectively. The two non-deposition portions of the cathode 10 are located on both sides of the cathode 10 included in the wound electrode body 22. The two elongated anode terminal tabs 13 of each of the wound electrode bodies 22 forming the lithium secondary battery 91 extend from the two non-deposition portions (end portions) of the anode 11, respectively. The two non-deposition portions of the anode 11 are located on both sides of the anode 11 included in the wound electrode body 22. Thus, a current path is provided by means of the two cathode tabs 12 and the two anode tabs 13. This structure makes it possible to reduce an electrical resistance of the battery and increase output power of the battery. In addition, the four wound electrode bodies 22 connected in parallel are housed in the battery can 72. Thus, the lithium secondary battery 91 has a higher output density than a lithium secondary battery having a structure in which four battery cans each housing one wound electrode body are connected in parallel. Furthermore, since the two cathode tabs 12 are attached to the cathode 10 and the two anode tabs 13 are attached to the anode 11, the manufacturing process and the battery structure are simplified in comparison with those of a lithium secondary battery having a structure in which a plurality of comb-tooth-shaped cutouts are formed on both sides of each of the cathode and the anode (i.e., the cutouts are located adjacent to shorter sides of each of the cathode and the anode).

The capacity of each of the wound electrode bodies 22 forming the lithium secondary battery 91 is set to a range of 0.8 Ah to 1.5 Ah. When the capacity of each of the wound electrode bodies 22 is less than 0.8 Ah, it is difficult to ensure that the lithium secondary battery 91 has a sufficient capacity. When the capacity of each of the wound electrode bodies 22 is more than 1.5 Ah, the cathode 10 and the anode 11 increase in length. Thus, distributions of currents flowing in the cathode 10 and the anode 11 may be biased. In this case, the lithium secondary battery 91 may not exhibit sufficient output characteristics. Furthermore, each of the wound electrode bodies 22 increases in radial length. Therefore, a large temperature difference occurs between the central side of each of the wound electrode bodies 22 and the outer side of each of the wound electrode bodies 22. The temperature difference is caused by heat generated by charging and discharging of the lithium secondary battery 91. The temperature difference may cause a reduction in the output characteristics of the lithium secondary battery 91. Setting the capacity of each of the wound electrode bodies 22 to a range of 0.8 Ah to 1.5 Ah can suppress a reduction in the output characteristics and the battery capacity.

Each of the cathode tab 12 and the anode tab 13 of the lithium secondary battery 91 has a cross-sectional area of 0.16 mm² to 0.4 mm², wherein the cross-sectional area of each of the cathode tab 12 and the anode tab 13 is taken in a direction crossing the direction in which a current flows in the electrode tab. This structure allows the lithium secondary battery 91 to have a reduced inner resistance and an increased output power. According as the cross-sectional areas of the cathode tab 12 and the anode tab 13 are restricted, the lithium secondary battery 91 has a small thickness. In addition, the restriction of the cross-sectional areas of the cathode tab 12 and the anode tab 13 suppresses, to a minimum extent, deformation of the wound electrode bodies 22 that would otherwise be caused by the presence of the cathode tab 12 and the anode tab 13 in a process of winding the cathode 10 and the anode 11. Each of the wound electrode bodies 22 has a square cross section in a direction crossing the winding axis. This structure reduces gaps between adjacent wound electrode bodies 22 (forming the wound electrode body group 41) that are arranged in line and in a flat shape. Thus, unnecessary gaps are not formed between the wound electrode body group 41 and the battery can 72 housing the wound electrode body group 41 and thereby the lithium secondary battery 91 has a higher gravimetric energy density.

The two cathode tabs 12 of each of the wound electrode bodies 22 forming the lithium secondary battery 91 extend in the same direction toward the same side with respect to the center of the wound electrode body. The two anode tabs 13 of each of the wound electrode bodies 22 forming the lithium secondary battery 91 extend in the same direction toward the same side with respect to the center of the wound electrode body. Therefore, the cathode tabs 12 can be easily connected to the cathode current conductive plate 52, and the anode tabs 13 can be easily connected to the anode current conductive plate 51. In addition, since the wound electrode bodies 22 are connected in parallel with each other via the cathode current conductive plate 52 and the anode current conductive plate 51, the lithium secondary battery 91 has a simpler battery structure and a lower resistance.

The lithium secondary battery 91 includes the insulating material located between the battery can 72 and the cathode current conductive plate 52 and the anode current conductive plate 51. The wound electrode body group 41 is housed in the battery can 72. Aluminum is used as a material of the cathode current conductive plate 52. Copper is used as a material of the anode current conductive plate 51. Thus, the cathode current conductive plate 52 is more lightweight than the anode current conductive plate 51. The wound electrode body group 41 is housed in the battery can 72 to ensure that the cathode tabs 12 are located on the bottom side of the battery can 72. This results from the fact that distances between the cathode tabs 12 and the battery lid 71 (cathode terminal 73) are large. As a result, the lithium secondary battery 91 has a reduced weight and an increased gravimetric energy density.

The lithium secondary battery 91 includes the cathode current conductive plate 52 having the cathode lead portion 52a. The cathode lead portion 52a is inclined with respect to the side plate portion 52c. The side plate portion 52c is located on the side of the one side surfaces of the wound electrode bodies 22 and extends in the longitudinal directions of the wound electrode bodies 22. The anode current conductive plate 51 has the anode lead portion 51a inclined with respect to the anode plate portion 51b. The anode plate portion 51b is located on the end surfaces (of the wound electrode bodies 22) from which the anode tabs 13 protrude. The cathode lead portion 52a is inclined at an acute angle with respect to the winding axes of the wound electrode bodies 22. Also, the anode lead portion 51a is inclined at an acute angle with respect to the winding axes of the wound electrode bodies 22. This structure reduces the amounts of materials of the cathode lead portion 52a and the anode lead portion 51a used, and reduces the resistance of the lithium secondary battery 91. The cathode lead portion 52a and the anode lead portion 51a are bent toward opposite sides to each other, i.e., toward the side of the centers of the end surfaces of the wound electrode bodies 22. Thus, the lithium secondary battery 91 has an appropriate space between the wound electrode body group 41 and the battery lid 71 and can make smaller than a conventional lithium secondary battery having the same capacity as the lithium secondary battery 91.

The cathode current conductive plate 52 has a larger cross sectional area than that of each cathode tab 12, wherein the cross sectional area of each cathode tab 12 is taken in a direction crossing the direction in which a current flows in the cathode tab 12. The anode current conductive plate 51 is a larger cross sectional area than that of each anode tab 13, wherein the cross sectional area of each anode tab 13 is taken in a direction crossing the direction in which a current flows in the anode tab 13. Thus, the lithium secondary battery 91 has a reduced resistance in current paths and higher output power compared with conventional lithium secondary batteries. One of the current paths extends from the cathode 10 to the cathode terminal 73. The other current path extends from the anode 11 to the anode terminal 74.

The cathode current conductive plate 52 has the guide portions 61. The guide portions 61 protrude from the side plate portion 52c. Each of the guide portions is in contact with the outer circumferential portions of any adjacent two of the wound electrode bodies 22. Since each of the guide portions 61 fits the shape of a recessed portion formed between the adjacent wound electrode bodies 22, the wound electrode bodies 22 are fixed in the battery can 72 by means of the guide portions 61. Thus, the lithium secondary battery 91 has a higher resistance to a shock and a vibration than conventional lithium secondary batteries. In addition, since each of the guide portions 61 is in contact with the adjacent wound electrode bodies 22, the lithium secondary battery 91 has a heat release property higher than those of conventional lithium secondary batteries. Even when the wound electrode bodies 22 generate heat during charging or discharging, the battery structure can reduce the aforementioned temperature difference of the lithium secondary battery 91 and suppress a reduction in the output power of the lithium secondary battery 91.

The lithium secondary battery module 112 including the eight lithium secondary batteries 91 has the spacers 92. Some of the spacers 92 are located between the lithium secondary batteries 91 arranged in the upper layer and the lithium secondary batteries 91 arranged in the lower layer. Some of the spacers 92 are located between adjacent lithium secondary batteries 91 arranged in the same layer. Those spacers 92 form gaps between the lithium secondary batteries 91. Thus, even when the lithium secondary batteries 91 forming the lithium secondary battery module 112 generate heat during charging or discharging, the heat is easily released from the lithium secondary battery module 112 due to the gaps present between the lithium secondary batteries 91. This structure suppresses an increase in the temperature of the lithium secondary battery module 112. As a result, the battery performance can be maintained.

As described above, the eight lithium secondary batteries 91 having high output performance and high energy densities are arranged and connected with each other in the lithium secondary battery module 112. As a result, the lithium secondary battery module 112 has high output power and a high energy density. Since the lithium secondary batteries 91 are downsized compared with conventional lithium secondary batteries, the lithium secondary battery module 112 can be downsized accordingly.

The six lithium secondary battery modules 112 are arranged in two columns and three rows and in a single layer and connected in series with each other in the exterior case 111 of the lithium secondary battery pack 121. Since the six lithium secondary battery modules 112 included in the lithium secondary battery pack 121 are capable of exhibiting high output performance and have high energy densities, the lithium secondary battery pack 121 is also capable of exhibiting higher output performance and has a higher energy density.

The lithium secondary battery pack 121 has the two cooling fans 114 attached to the exterior case 111. The two cooling fans 114 are respectively arranged at the locations associated with the substantially active portions of the side surfaces of two columns of the lithium secondary battery modules 112. Thus, even when the lithium secondary batteries forming the lithium secondary modules 112 housed in the exterior case 111 are charged or discharged and generate heat, the lithium secondary battery pack 121 can release hot air to the outside of the pack 121. Since the gaps are provided between the lithium secondary batteries 91 forming the lithium secondary battery modules 112 by means of the spacers 92, the lithium secondary battery pack 121 can efficiently release the hot air. The lithium secondary battery modules 112 are arranged in the single layer in the exterior case 111 of the lithium secondary battery pack 121. Thus, the lithium secondary battery pack 121 is formed into a thin shape. The lithium secondary battery pack 121 can be installed on the bottom of an electric vehicle or hybrid vehicle and is suitable to ensure a vehicle interior space.

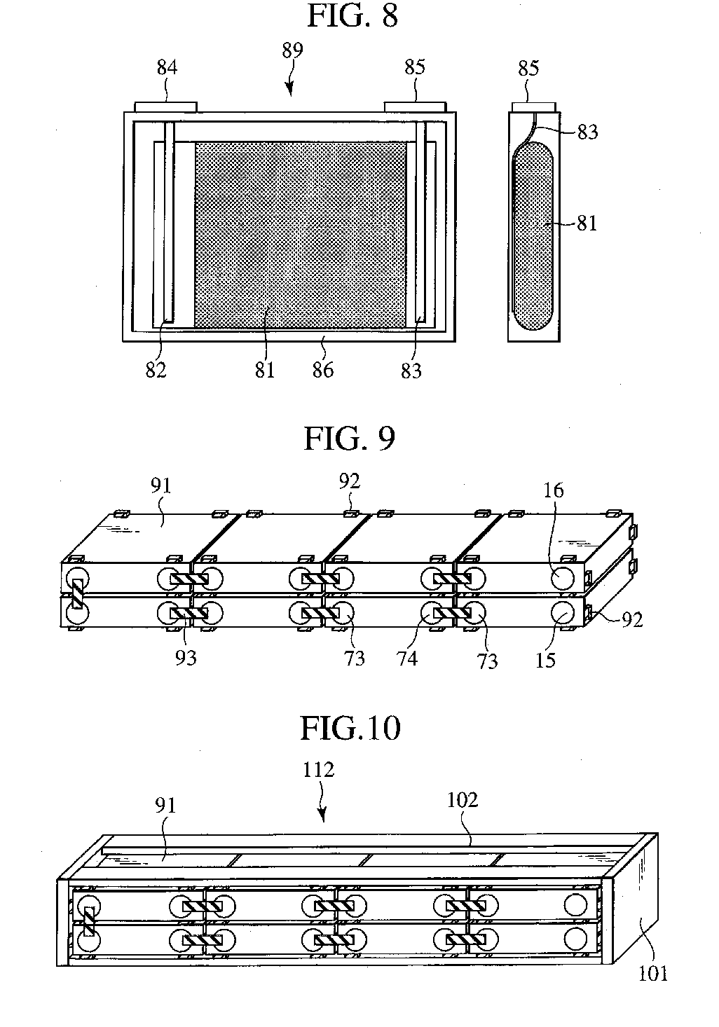

A conventional rectangular parallelepiped lithium secondary battery has a thin flat wound electrode body and a battery can. The conventional battery can houses the thin flat wound electrode body. The thin flat wound electrode body is formed by winding a cathode and an anode with a separator located between the cathode and the anode. Referring to FIG. 8, a conventional rectangular parallelepiped lithium secondary battery 89 has a thin rectangular parallelepiped battery can 86. The battery can 86 has an opening on its top side. The opening of the battery can 86 is sealed by a battery lid. The battery lid has a cathode terminal 84 and an anode terminal 85 erected. The battery can 86 houses a flat wound electrode body 81 to ensure that the winding axis of the wound electrode body 81 extends in a substantially horizontal direction. Each of the cathode and the anode has a non-deposition portion on its one end side. That is, the non-deposition portion of each of the cathode and the anode includes one entire shorter side of the electrode plate. An active material is not deposited on the non-deposition portion of each of the cathode and the anode. The non-deposition portions of the cathode and the anode of the flat wound electrode body 81 are exposed on opposite sides to each other. A single cathode tab 82 is attached to the non-deposition of the cathode, while a single anode tab 82 is attached to the non-deposition of the anode. The cathode tab 82 is connected to the cathode terminal 84. The anode tab 83 is connected to the anode terminal 85. It can be expected that a plurality of the rectangular parallelepiped lithium secondary batteries 89 are connected to each other to form a secondary battery module and a secondary battery pack in order to increase output power and a capacity. In such a structure, however, an active portion of the flat wound electrode body 81, which is located between the cathode tab 82 and the anode tab 83, may easily expands. When the flat wound electrode body 81 expands, an anode active material may be removed from an anode current collector foil (copper foil). This may result in a reduction in output power of the lithium secondary battery 89 or/and a reduction in the capacity of the lithium secondary battery 89. To increase output power of a lithium secondary battery, a technique is known which a cylindrical wound electrode body formed by winding a cathode having multiple tabs (protruding from the cathode) and an anode having multiple tabs (protruding from the anode) is housed in a cylindrical case. However, a process of manufacturing the cylindrical wound electrode body becomes complex, since it is necessary to protrude the multiple tabs from each of the cathode and the anode. When a plurality of the cylindrical batteries are connected to form a secondary battery module or a secondary battery pack, a ratio of parts such as a battery can and the like to the secondary battery module or the secondary battery pack is large. This may result in a reduction in an energy density of the secondary battery module or the secondary battery pack. The lithium secondary battery, the lithium secondary battery module and the lithium secondary battery pack according to the present embodiment can solve the above problems.

The cathode 10 of the lithium secondary battery 91 according to the present embodiment has the two non-deposition portions on both end sides thereof. The two cathode tabs 12 protrude from the two non-deposition portions of the cathode 10, respectively. Also, the anode 11 of the lithium secondary battery 91 according to the present embodiment has the two non-deposition portions on both end sides thereof. The two anode tabs 13 protrude from the two non-deposition portions of the anode 11, respectively. However, the number of each of the cathode tabs 12 and the anode tabs 13 is not limited in the present invention. For example, two cathode tabs 12 may be attached to and protrude from each of the two non-deposition portions of the cathode 10. An increase in the numbers of the cathode tab 12 and the anode tab 13 increases the size of the current paths and reduces the resistance of the lithium secondary battery 91.

Each of the wound electrode bodies 22 included in the lithium secondary battery 91 has a square cross section in a direction crossing the winding axis of the wound electrode body 22. The present invention, however, is not limited to this structure. As shown in FIG. 2B, the lithium secondary battery 91 may have wound electrode bodies 21. Each of the wound electrode bodies 21 has a circular cross section in a direction crossing a winding axis of the wound electrode body 21. A wound electrode body having another cross section (in a direction crossing a winding axis of the wound electrode body) can be formed by using a shaft (used to wind the wound electrode body) having a different cross section. Each of the wound electrode body 22 may have a shaft (used to wind the wound electrode body) in a central region (of the body 22) extending along the winding axis. In addition, the shaft may be removed from the wound electrode body 22 after the wound electrode body 22 is formed.

The lithium secondary battery 91 includes the wound electrode body group 41 having the four wound electrode bodies 22 connected in parallel to each other. The present invention, however, is not limited to this structure. The lithium secondary battery 91 has only to have a plurality of wound electrode bodies 22 connected to each other. For example, the lithium secondary battery 91 may include five wound electrode bodies 22 connected in parallel to each other to increase a battery capacity. The lithium secondary battery 91 according to the present embodiment includes the thin rectangular parallelepiped battery can 72. The battery can 72 has substantially right-angle corners. Specifically, each corner of the battery can 72, which is located between a certain surface (that is substantially perpendicular to a surface of the battery lid 71) of the battery can 72 and another surface (adjacent to the certain surface) of the battery can 72, forms a substantially right angle. The present invention, however, is not limited to this structure. The battery can 72 may have curved corners.

The lithium secondary battery 91 includes the aforementioned various materials such as the cathode active material, the anode active material and the electrolyte. The present invention, however, is not limited to this. The lithium secondary battery 91 may include a material used for a typical lithium secondary battery.

The lithium secondary battery module 112 includes the eight lithium secondary batteries 91 connected in series. The present invention, however, is not limited to this structure. The number of the lithium secondary batteries 91 forming the lithium secondary battery module 112 may be changed. In addition, the lithium secondary batteries 91 forming the lithium secondary battery module 112 may be connected in parallel or in series-parallel.

The lithium secondary battery module 112 includes the plurality of spacers 92, some of which are located between adjacent lithium secondary batteries 91. The present invention is not limited in where the spacers 92 are positioned or how much the spacers 92 are provided. Each spacer 92 is not limited in shape and material.

The lithium secondary battery pack 121 includes the six lithium secondary battery modules 112 connected in series. The present invention, however, is not limited to this structure. The number of the lithium secondary battery modules 112 forming the lithium secondary battery pack 121 may be changed. The lithium secondary battery modules 112 forming the lithium secondary battery pack 121 may be connected in parallel or in series-parallel. The lithium secondary battery pack 121 includes the control circuit 113 that controls the battery states of the lithium secondary batteries 91 forming each lithium secondary battery module 112 housed in the exterior case 111. The configuration of the control circuit 113 is not limited by the present invention. The control circuit 113 has only to control the battery states of the lithium secondary batteries 91.

The lithium secondary battery modules 112 included in the lithium secondary battery pack 121 are arranged in a single layer. The present invention, however, is not limited to this structure. When the lithium secondary battery modules 112 included in the lithium secondary battery pack 121 are arranged in a single layer, the lithium secondary battery pack 121 is thin. Thus, the lithium secondary battery pack 121 having the lithium secondary battery modules 112 arranged in a single layer are suitable as a power supply for a electric vehicle or the like in order to ensure a vehicle interior space.

### EXAMPLES

The following describes examples of the lithium secondary battery 91, the lithium secondary battery module 112 and the lithium secondary battery pack 121, which are formed according to the present embodiment. The present invention, however, is not limited to the examples. The first and second examples describe the lithium secondary battery 91. The third example describes the lithium secondary battery module 112. The fourth example describes the lithium secondary battery pack 121. In addition, another lithium secondary battery is described as a comparative example below.

### First Example

### Formation of Cathode

A nickel oxide, a manganese oxide and a cobalt oxide are used as materials of the cathode active material in the first example. Those oxides are prepared to ensure that atom ratios of Ni, Mn and Co are 1:1:1. The three types of oxides are pulverized and mixed by a wet pulverizer. Polyvinyl alcohol (PVA) is added to the pulverized and mixed material (oxides). The thus-obtained powder is granulated by a spray dryer. The granulated powder is introduced into a high-purity alumina container. Then, the powder is temporarily fired at a temperature of 600° C. for 12 hours to evaporate the PVA. The powder is then cooled. After the cooling, the powder is disintegrated. Then, lithium hydroxide monohydrate is added to and sufficiently mixed with the disintegrated powder to ensure that atom ratios of Ni, Mn and Co (transition metals) are 1:1:1. The mixed powder is introduced into a high-purity alumina container and fired at a temperature of 900° C. for 6 hours to obtain the cathode active material. The obtained cathode active material is disintegrated and classified. The average diameter of particles of the obtained cathode active material is 6 μm.

The obtained cathode active material, blocky graphite (used as a conductive material), flaky graphite (used as the conductive material), amorphous carbon (used as the conductive material) and PVDF (binder) are mixed to ensure that weight ratios of the obtained cathode active material, the blocky graphite, the flaky graphite, the amorphous carbon and the PVDF are 85:7:2:2:4. Then, N-methyl-2-pyrrolidone with an appropriate amount is added to the mixed material to form slurry. The formed slurry is thoroughly stirred for 3 hours by a planetary mixer. Then, the slurry is coated on a surface of an aluminum foil having a thickness of 20 μm by means of a roll transfer type coater. The slurry is also coated on the opposite surface of the aluminum foil in the same manner to form the cathode 10. Then, the thus-formed cathode 10 is dried at a temperature of 120° C. After that, the cathode 10 is pressed at a pressure of 250 kg/mm by a roll press machine. The density of the cathode mixture of the obtained cathode 10 is 2.4 g/cm³.

### Formation of Anode

Amorphous carbon is used to form an anode. The average diameter of particles of the amorphous carbon is 10 μm. Carbon blacks (used as a conductive material) are added to the amorphous carbon to ensure that the weight percent of the carbon blacks relative to the total amount of the amorphous carbon having the carbon blacks added thereto is 6.5. Then, PVDF is added to the amorphous carbon containing the carbon blacks. Then, the amorphous carbon containing the carbon blacks and the PVDF is thoroughly stirred for 30 minutes by a planetary mixer to form slurry. The formed slurry is coated on both surfaces of a copper foil having a thickness of 10 μm by means of a coater. Then, the copper foil having the slurry coated thereon is dried and then pressed by a roll press machine to form the anode 11. The density of the anode mixture of the anode 11 is 1.0 g/cm³.

### Assembling of Rectangular Parallelepiped Battery

The cathode tabs 12 are attached to the cathode 10. The anode tabs 13 are attached to the anode 11. Then, the cathode 10 and the anode 11 are wound to ensure that the separator 14 is located between the cathode 10 and the anode 11. The widths of the cathode tabs 12 and 13 are 3 mm, and the cross sectional areas of the cathode tabs 12 and 13 are in a range of 0.3 mm² to 0.4 mm², in order to simplify the assembling work. The capacity of each of the wound electrode bodies 22 is 1.5 Ah. The cathode current conductive plate 52 having the fixing guide portions 61 is connected to the cathode tabs 12 of the four wound electrode bodies 22, and the anode current conductive plate 51 is connected to the anode tabs 13 of the four wound electrode bodies 22. The four wound electrode bodies 22 are arranged in line and fixed by means of the guide portions 61 to form the wound electrode body group 41. The wound electrode body group 41 is housed in the battery can 72. The cathode tabs 12 connected with the cathode current conductive plate 52 are connected to the cathode terminal 73. The anode tabs 13 connected with the anode current conductive plate 51 are connected to the anode terminal 74. The battery lid 71 is fixed to the battery can 72. A nonaqueous electrolyte is poured from the liquid port 75 formed in the battery lid 71. The liquid port 75 is closed to seal the battery can 72. In this way, the lithium secondary battery 91 is formed.

### Comparative Example

In the comparative example, the cathode 10 and the anode 11 are formed in the same manner as the formations described in the first example. The cathode tabs 82 are joined to the non-deposition portions (located on both end sides of the cathode 10) of the cathode 10 by ultrasonic welding, respectively. The anode tabs 83 are joined to the non-deposition portions (located on both end sides of the anode 11) of the anode 11 by ultrasonic welding, respectively. The cathode tabs 82 are made of aluminum, and the anode tabs 83 are made of nickel. The cathode 10 and the anode 11 are wound to form the flat wound electrode body 81. In this case, the separator 14 is provided between the cathode 10 and the anode 11. The thus-formed flat wound electrode body 81 is housed in the battery can 86 made of aluminum. The cathode tabs 82 are joined to the cathode terminal 84 by welding. The anode tabs 83 are joined to the anode terminal 85 by welding. After that, a battery lid is attached to the battery can 86. Lastly, an electrolyte is poured from a liquid port formed in the battery lid. The liquid port is then closed to seal the battery can. In this way, the lithium secondary battery 89 is formed (refer to FIG. 8). As the electrolyte, an organic electrolyte (nonaqueous electrolyte) is used. To form the organic electrolyte, EC, DMC and EMC are mixed to ensure that volume ratios of the EC, DMC and EMC are 1:1:1. Then, lithium hexafluorophosphate (LiPF₆) is dissolved into the thus-mixed solvent containing the EC, the DMC and the EMC to ensure that LiPF₆ has a concentration of 1 mol/l. The lithium secondary battery 89 obtained in the comparative example has a battery capacity of 6 Ah.

### Pulse Charging/Discharging Test

A pulse charging/discharging test was carried out on the lithium secondary battery 91 described in the first example and the lithium secondary 89 described in the comparative example under the following conditions.

(1) Center voltage during charging and discharging: 3.6 V
(2) Discharging pulse: current of 72 A, time of 30 seconds
(3) Charging pulse: current of 36 A, time of 15 seconds
(4) Stop time between discharging and charging: 30 seconds
(5) Since the center voltage varies, constant-voltage (3.6 V) charging or constant-voltage (3.6 V) discharging was carried out for each 1000 pulses to set the center voltage to 3.6 V.
(6) The temperature of the environment surrounding the battery was set to 50° C.

The pulse charging/discharging test was repeated to calculate the direct current resistance and output density of the lithium secondary battery 91 and the direct current resistance and output density of the lithium secondary battery 89 based on the following method. In the method, the lithium secondary batteries 91 and 89 were discharged at currents of 24 A, 48 A, 72 A and 96 A (in this order) at a temperature of 50° C. for 10 seconds. The relationships between the discharging currents and voltages measured at the time when 10 seconds had elapsed were plotted to obtain an inclined straight line for each of the lithium secondary battery 91 and 89. The direct current resistances were calculated based on the inclination of the inclined straight line for each of lithium secondary battery 91 and 89. A current value corresponding to a voltage of 2.5 V was calculated based on the straight line for each of the lithium secondary batteries 91 and 89. The product of the voltage of 2.5 V and the current value of the lithium secondary battery 91 was divided by the weight of the lithium secondary battery 91 to calculate the output density. Also, the product of the voltage of 2.5 V and the current value of the lithium secondary battery 89 was divided by the weight of the lithium secondary battery 89 to calculate the output density. Based on the calculated direct current resistances, resistance increase rates were calculated in percentage by using the initial direct current resistances as 100 (the repeated pulse charging/discharging test increases the resistances of the lithium secondary batteries 91 and 89).

Referring to FIG. 12, the resistance increase rate of the lithium secondary battery 89 described in the comparative example was about 160% when the pulse charging/discharging test was repeatedly carried out 300,000 times. In contrast, the resistance increase rate of the lithium secondary battery 91 described in the first example was about 120% or less when the pulse charging/discharging test was repeatedly carried out 300,000 times. The resistance increase rate of the battery 91 was smaller than that of the battery 89. It has been apparent that the lithium secondary battery 91 has a longer lifetime.

### Second Example

In the second example, wound electrode bodies each having a capacity of 1.0 Ah, wound electrode bodies each having a capacity of 1.2 Ah, and wound electrode bodies each having capacity of 2.0 Ah are formed in the same way as the first example. The cross sectional areas of the cathode tab 12 and the anode tab 13 of each of the wound electrode bodies are in a range of 0.3 mm² to 0.4 mm². Six wound electrode bodies having capacities of 1.0 Ah are connected in parallel. Five wound electrode bodies having capacities of 1.2 Ah are connected in parallel. Three wound electrode bodies having capacities of 2.0 Ah are connected in parallel. The aforementioned pulse charging/discharging test was carried out on each of lithium secondary batteries, which are a lithium secondary battery having the wound electrode bodies each having a capacity of 1.0 Ah, a lithium secondary battery having the wound electrode bodies each having capacity of 1.2 Ah and a lithium secondary battery having the wound electrode bodies each having capacity of 2.0 Ah to measure an initial output density of each lithium secondary battery and measure a resistance increase rate of each lithium secondary battery after the pulse charging/discharging test of 300,000 times. The output densities and the resistance increase rates are indicated in Table 1 shown below. A lithium secondary battery including wound electrode bodies each having capacity of 1.5 Ah, which is shown in Table 1, indicates the lithium secondary battery 91 described in the first example.

TABLE 1

| | Number of wound | | |
|---|---|---|---|
| Capacity | electrode bodies | Initial | Resistance |
| of each wound | included in | output | increase rate |
| electrode | rectangular | density | after 300,000 |
| body (Ah) | parallelepiped battery | (W/kg) | pulses (%) |
| 1.0 | 6 | 3700 | 122 |
| 1.2 | 5 | 3750 | 121 |
| 1.5 | 4 | 3800 | 120 |
| 2.0 | 3 | 3480 | 129 |

As shown in Table 1, the initial output density and resistance increase rate of the lithium secondary battery including the wound electrode bodies each having a capacity of 2.0 Ah are 3480 W/kg and 129%. The initial output densities of the lithium secondary batteries including the wound electrode bodies each having a capacity ranging from 1.0 to 1.5 Ah are larger than that of the lithium secondary battery including the wound electrode bodies each having a capacity of 2.0 Ah. The resistance increase rates of the lithium secondary batteries including the wound electrode bodies having capacities of 1.0 to 1.5 Ah are smaller than that of the lithium secondary battery including the wound electrode bodies having capacities of 2.0 Ah. It is therefore found that a lithium secondary battery including wound electrode bodies having capacities of more than 1.5 Ah exhibits a little lower initial output density and a little higher resistance increase rate. This is because a wound electrode body having a capacity of more than 1.5 Ah exhibits a large temperature distribution and a large current distribution. In addition, it is contemplated that the cathode tab 12 and the anode tab 13 having cross sectional areas of 0.3 mm² to 0.4 mm² contribute to a reduction in the resistance of the lithium secondary battery. In the second example, the cathode tab 12 and the anode tab 13 have the same cross sectional areas, regardless of the capacity of each wound electrode body. However, the cross sectional areas of the cathode tab 12 and the anode tab 13 may be changed based on the capacities of the wound electrode bodies. For example, when the wound electrode bodies each have a capacity of 1.0 Ah or 1.2 Ah, and the cross sectional areas of the cathode tab 12 and the anode tab 13 are in the range of 0.3 mm² to 0.4 mm², such a structure leads to excessive quality (although there is no problem with the battery manufacturing and the cost of the battery). The following structure is suitable. The wound electrode bodies each have a capacity of 1.5 Ah, and the cross sectional areas of the cathode tab 12 and the anode tab 13 are in the range of 0.3 mm² to 0.4 mm². When the capacities of the wound electrode bodies are small, it is desirable to set the cross sectional areas of the cathode tab 12 and the anode tab 13 to be small so as to ensure that the capacities of the wound electrode bodies are in proportion to the cross sectional areas of the cathode tab 12 and the anode tab 13 (for example, when the wound electrode bodies each have a capacity of 1.0 Ah, the cross sectional areas of the tabs 12 and 13 are in a range of 0.2 mm² to 0.27 mm²). It has been confirmed that such a structure exhibits the aforementioned effect.

### Third Example

In the third example, the rectangular parallelepiped lithium secondary batteries 91 formed in the first example are used to form the lithium secondary battery module 112 (refer to FIGS. 9 and 10). Four of the lithium secondary batteries 91 are horizontally arranged in a single layer, and the other four lithium secondary batteries 91 are horizontally arranged in another single layer. That is, the eight lithium secondary batteries 91 are arranged in the two layers. Some of the spacers 92 are located between each adjacent pair of the lithium secondary batteries 91 to form spaces for heat release. The plate-shaped connecting metal fitting 93 is connected by welding to the cathode terminal 73 of each lithium secondary battery 91 and the anode terminal 74 of the adjacent lithium secondary battery 91. Thus, the lithium secondary batteries 91 are connected in series to each other by means of the connecting metal fittings 93. The end plates 101 are fixed by means of the tightening plates 102. In this way, the lithium secondary battery module 112 is formed. As shown in Examples 1 and 2, it has been confirmed that the lithium secondary battery module 112 including the lithium secondary batteries 91 having excellent output characteristics and excellent energy densities also has an excellent output characteristic and an excellent energy density.

### Fourth Example

In the fourth example, the lithium secondary battery modules 112 formed in the third example are used to form the lithium secondary battery pack 121 (refer to FIG. 11). The lithium secondary battery modules 112 are arranged in two columns and three rows and in a single layer. The six lithium secondary modules 112 are connected in series. Then, the six lithium secondary modules 112 are housed in the exterior case 111 to form the lithium secondary battery pack 121. The lithium secondary battery pack 121 has the control circuit 113 and the cooling fans 114. It has been confirmed that the lithium secondary battery pack 121 including the lithium secondary battery modules 112 having excellent output characteristics and excellent energy densities also has an excellent output characteristic and an excellent energy density. Since the thin lithium secondary battery pack 121 is made thin, it can be installed on the floor bottom of an electric vehicle or hybrid vehicle and is suitable to ensure a vehicle interior space.

The present invention provides the lithium secondary battery having improved output power, the lithium secondary battery module having the plurality of lithium secondary batteries connected to each other, and the lithium secondary battery having the lithium secondary battery modules connected to each other. Thus, the present invention contributes to manufacturing and sales of the lithium secondary battery, the lithium secondary battery module and the lithium secondary battery pack and is useful in the battery industry.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A lithium secondary battery comprising:
a plurality of wound electrode bodies;
an electrolyte for infiltrating the wound electrode bodies; and
a battery case housing the wound electrode bodies and the electrolyte;
wherein each of said plurality of wound electrode bodies comprises:
a cathode;
an anode;
a separator located between the cathode and the anode; and
first and second cathode conducting members, said first cathode conducting member extending from a central portion of the respective wound electrode body, said second cathode conducting member extending from an exterior portion of the respective would electrode body, and said first and second cathode conducting members being connected to each other; and
first and second anode conducting members, said first anode conducting member extending from a central portion of the respective wound electrode body, said second anode conducting member extending from an exterior portion of the respective would electrode body, and said first and second anode conducting members being connected to each other,
wherein each of said wound electrode bodies has a capacity of 1.5 Ah or less, and
wherein a cross sectional area of each of said anode conducting members is 0.4 mm² or less and of each of said cathode conducting members is 0.4 mm² or less.

2. The lithium secondary battery according to claim 1, wherein
said wound electrode bodies are connected in parallel to each other in the battery case.

3. The lithium secondary battery according to claim 1, wherein
said cathode comprises a cathode current collector and a cathode active material on said cathode current collector, wherein said cathode current collector is not covered by said cathode active material at an inner edge and an outer edge of the cathode, and
said anode comprises an anode current collector and an anode active material on said anode current collector, wherein said anode current collector is not covered by said anode active material at an inner edge and an outer edge of the anode,
wherein said first cathode conducting member is connected on said uncovered portion of said cathode current collector at said inner edge of said cathode,
wherein said second cathode conducting member is connected on said uncovered portion of said cathode current collector at said outer edge of said cathode,
wherein said first anode conducting member is connected on said uncovered portion of said anode current collector at said inner edge of said anode, and
wherein said second anode conducting member is connected on said uncovered portion of said anode current collector at said outer edge of said anode.

4. The lithium secondary battery according to claim 1, wherein
the wound electrode bodies are connected to each other in the battery case by connecting the cathode conducting members to each other and connecting the anode conducting members to each other.

5. The lithium secondary battery according to claim 1, wherein
the cathode conducting members of each of the wound electrode bodies extend in a same direction and parallel with respect to an axis of the respective wound electrode body, and
the anode conducting members of each of the wound electrode bodies extend in an opposite direction of the cathode conducting members.

6. The lithium secondary battery according to claim 1, wherein
the conducting members of each of the wound electrode bodies are parallel to the conducting members of other wound electrode bodies.

7. The lithium secondary battery according to claim 1, wherein
each of the wound electrode bodies has a circular, square, or rectangular cross section in a direction crossing the direction of a winding axis of the respective wound electrode body.

8. The lithium secondary battery according to claim 1, further comprising:
a cathode current conductive plate that connects the cathode conducting members; and
an anode current conductive plate that connects the anode conducting members.

9. The lithium secondary battery according to claim 8, wherein
the wound electrode bodies are arranged in a line and housed in the battery case to ensure that the cathode current conductive plate is located on a bottom side of the battery case and that an insulating material is placed between the battery case and the cathode current conductive plate.

10. The lithium secondary battery according to claim 9, wherein
the cathode current conductive plate has a cathode side plate portion and a cathode plate portion located on a bottom side of the battery case,
wherein the cathode plate portion and the cathode side plate portion form an L shape, and
the anode current conductive plate has an anode plate portion located on an opposite side of the cathode plate portion with respect to the wound electrode bodies.

11. The lithium secondary battery according to claim 10,
wherein the cathode current conductive plate further comprises a cathode lead portion connected to an external cathode terminal, and
the anode current conductive plate further comprises an anode lead portion connected to an external anode terminal.

12. The lithium secondary battery according to claim 11, wherein
each of the cathode current conductive plate and the anode current conductive plate has a cross sectional area larger than that of each of the cathode conducting members and the anode conducting members in the direction crossing the current flow direction.

13. The lithium secondary battery according to claim 10, wherein
the cathode current conductive plate has a contact member placed on the cathode side plate portion and in contact with outer circumferential portions of the wound electrode bodies.

14. The lithium secondary battery according to claim 1, wherein
a cross sectional area of each of said conducting members is from 0.16 mm² to 0.4 mm².

15. A secondary battery module comprising:
a plurality of lithium secondary batteries described in claim 1,
wherein the lithium secondary batteries are arranged in a row and spacers form gaps between adjacent pairs of lithium secondary batteries.

16. The secondary battery module according to claim 15, further comprising:
a second row of lithium secondary batteries, wherein spacers form gaps between adjacent pairs of lithium secondary batteries, and wherein spacers form gaps between said first and second rows of lithium batteries.

17. A secondary battery pack comprising:
a plurality of secondary battery modules described in claim 15;
a control circuit that controls battery states of the lithium secondary batteries forming each of the secondary battery modules; and
an exterior case that houses the plurality of secondary battery modules and the control circuit.

18. The secondary battery pack according to claim 17, wherein
the secondary battery modules are arranged in a single horizontal row and connected in series to each other.

19. The secondary battery pack according to claim 17, wherein
the exterior case has a heat release fan that releases internal heat to outside of the exterior case.

20. A wound electric body for use in a lithium secondary battery comprising;
a cathode;
an anode;
a separator located between the cathode and the anode;
first and second cathode conducting members, said first cathode conducting member extending from a central portion of the wound electrode body, and said second cathode conducting member extending from an exterior portion of the would electrode body; and
first and second anode conducting members, said first anode conducting member extending from a central portion of the wound electrode body, said second anode conducting member extending from an exterior portion of the would electrode body;
wherein said wound electrode body has a capacity of 1.5 Ah or less, and
wherein a cross sectional area of each of said anode conducting members is 0.4 mm² or less and of each of said cathode conducting members (12) is 0.4 mm² or less.
